(19) United States
(12) Patent Application Publication
(10) Pub. No.: US 2023/0172227 A1
(43) Pub. Date: Jun. 8, 2023

(54) METHOD OF MAKING A TUNA ANALOGUE COMPOSITION

(71) Applicant: SOCIETE DES PRODUITS NESTLE S.A., Vevey (CH)

(72) Inventors: JEAN-CLAUDE DELASOIE, Chatham, NJ (US); PAULA GUERRA QUIROZ, Lausanne (CH); WALTER MATTHEY-DORET, Prilly (CH); OLIVER NUSSLI, Oberdorf (CH); PATRICK PIBAROT, Territet (CH)

(21) Appl. No.: 17/997,079

(22) PCT Filed: Apr. 29, 2021
(86) PCT No.: PCT/EP2021/061257

§ 371 Date: Oct. 25, 2022

(30) Foreign Application Priority Data
Apr. 30, 2020 (EP) 20172522.3

(51) Int. Cl. A23J 3/18; A23J 3/16; A23J 3/22

(52) U.S. Cl. CPC A23J 3/18; A23J 3/16; A23J 3/227

(57) ABSTRACT

The present invention relates to a method of making a tuna analogue, said method comprises mixing at least two different plant proteins, wherein said plant proteins comprise wheat gluten and at least one other plant protein, preferably pea protein, and wherein wheat gluten comprises between 10 to 40% of total plant protein in the plant protein mixture; applying heat and pressure to the plant protein mixture to form a fibrous protein product; washing the fibrous protein product in a liquid at least once; adding a non-animal based tuna flavour to the fibrous protein product and mixing to form a tuna analogue.

### BACKGROUND OF THE INVENTION

Vegan food has seen a rapid rise in popularity in recent years, particularly meat analogues, but also fish analogues such as tuna.

Conventional tuna is used in many traditional dishes such as salads, pizzas, and sandwiches. However, as a product of animal origin, it is unsuitable for vegans and vegetarians, thus reducing its attractiveness to these increasingly important consumer groups.

Tuna analogues made without fish already exist on the market. Many vegan or vegetarian tuna dishes can also be made at home using recipes found on the internet. Chickpea and jack fruit are especially popular ingredients. For the most part, prior art tuna analogues suffer from having an unrealistic appearance. They also lack a fibrous texture, and do not have the consistency or chewing characteristics of conventional tuna.

There is a clear need to develop new tuna analogues that address the problems of the current offerings on the market.

### SUMMARY OF THE INVENTION

The inventors have developed a method of making a tuna analogue which surprisingly results in a product substantially superior in appearance, texture, consistency, and chewing characteristics compared to tuna analogues on the market.

In a first aspect, the invention provides a method of making a tuna analogue, said method comprising

a. Preparing a plant protein mixture by mixing at least two different plant proteins, wherein said plant proteins comprise wheat gluten and at least one other plant protein;

b. Applying heat and pressure to the plant protein mixture; and

c. Washing the fibrous protein product in a liquid at least once.

In a further aspect, the invention provides a method of making a tuna analogue, said method comprising

a. Preparing a plant protein mixture by mixing at least two different plant proteins, wherein said plant proteins comprise wheat gluten and at least one other plant protein selected from pea protein, soy protein, faba bean protein, and canola protein;

b. Applying heat and pressure to the plant protein mixture; and

c. Washing the fibrous protein product in a liquid at least once.

In a further aspect, the invention provides a method of making a tuna analogue, said method comprising

a. Preparing a plant protein mixture by mixing at least two different plant proteins, wherein said plant proteins comprise wheat gluten and at least one other plant protein selected from pea protein, soy protein, faba bean protein, and canola protein;

b. Applying heat and pressure to the plant protein mixture to form a fibrous protein product; and

c. Washing the fibrous protein product in a liquid at least once.

In a further aspect, the invention provides a method of making a tuna analogue, said method comprising

a. Preparing a plant protein mixture by mixing at least two different plant proteins, wherein said plant proteins comprise wheat gluten and at least one other plant protein selected from pea protein, soy protein, faba bean protein, and canola protein;

b. Applying heat and pressure to the plant protein mixture to form a fibrous protein product; and

c. Washing the fibrous protein product in a liquid at least once, wherein the fibrous protein product is allowed to absorb the liquid, and wherein the liquid has a temperature of between 60 to 95° C.

In a further aspect, the invention provides a method of making a tuna analogue, said method comprising

a. Preparing a plant protein mixture by mixing at least two different plant proteins, wherein said plant proteins comprise wheat gluten and at least one other plant protein selected from pea protein, soy protein, faba bean protein, and canola protein;

b. Applying heat and pressure to the plant protein mixture to form a fibrous protein product;

c. Washing the fibrous protein product in a liquid at least once, wherein the fibrous protein product is allowed to absorb the liquid, and wherein the liquid has a temperature of between 60 to 95° C.;

d. Adding a non-animal based tuna flavour to the fibrous protein product and mixing to form a tuna analogue; and

e. Optionally retorting or pasteurizing the tuna analogue.

In a further aspect, the invention provides a method of making a tuna analogue, said method comprising

a. Preparing a plant protein mixture by mixing at least two different plant proteins, wherein said plant proteins comprise wheat gluten and at least one other plant protein selected from pea protein, soy protein, faba bean protein, and canola protein, and wherein wheat gluten comprises between 10 to 40 wt % of total plant protein in the plant protein mixture;

b. Applying heat and pressure to the plant protein mixture to form a fibrous protein product;

c. Washing the fibrous protein product in a liquid at least once, wherein the fibrous protein product is allowed to absorb the liquid, and wherein the liquid has a temperature of between 60 to 95° C.;

d. Adding a non-animal based tuna flavour to the fibrous protein product and mixing to form a tuna analogue; and

e. Optionally retorting or pasteurizing the tuna analogue.

The choice of plant proteins used to make the plant protein mixture is important for obtaining a satisfactory product.

In a preferred embodiment, the plant protein mixture comprises wheat gluten and pea protein, preferably in the ratio of about 30:70. In some embodiments, the plant protein mixture comprises wheat gluten and one or more pea proteins, for example two different pea proteins.

Heat is applied to the plant protein mixture so that the plant protein mixture reaches a temperature greater than 130° C., preferably greater than 145° C., most preferably greater than 160° C.

Pressure is applied to the plant protein mixture, such that the plant protein is subjected to a pressure greater than atmospheric pressure.

In some embodiments, heat and pressure are applied to the plant protein mixture using a wet extrusion process to form a fibrous protein product.

In some embodiments, the wet extrusion process comprises passing the plant protein mixture through an extruder to form a fibrous protein product; and collecting the fibrous protein product. The fibrous protein product is washed in a liquid at least once. The fibrous protein product is allowed to absorb the liquid. Preferably, the fibrous protein product is immersed in the liquid after the fibrous protein product is collected during the wet extrusion process.

If the temperature of the liquid is too high, then the fibrous protein product becomes too dense. If the temperature of the liquid is too low, then not enough off flavours are removed from the fibrous protein product. The liquid has a temperature of between 60° C. to 95° C. Preferably, the liquid has a temperature of about 85° C.

In some embodiments, the liquid is water. In some embodiments, the liquid is a broth, wherein the broth comprises flavours and salts.

Typically, the liquid is partially removed from the fibrous protein product by draining or pouring off after washing. Preferably, the fibrous protein product is washed in a liquid at least twice. Preferably, the temperature of the fibrous protein product is reduced to about 20° C. after each washing.

Preferably, the fibrous protein product has a moisture content of more than 70% after washing.

Typically, the fibrous protein product is then cooled down. In one embodiment, the fibrous protein product is cooled down to about ambient temperature, for example to 25° C. or less. In one embodiment, the fibrous protein product is cooled down with water, wherein said water is about 15° C. The advantage of cooling down the fibrous protein product is that the maximum amount of non-animal based tuna flavour can be retained once it has been added.

Typically, the fibrous protein product does not have substantially aligned protein fibres. In some embodiments, at least about 55%, at least about 65%, at least about 75%, at least about 85%, or at least about 95% of the protein fibres are not substantially aligned.

A non-animal based tuna flavour is added to the fibrous protein product and mixed to form a tuna analogue. Typically, the non-animal based tuna flavouring is mixed with other flavours in oil before adding to the plant protein mixture. This allows a more homogenous mixing to occur. The viscosity of the oil keeps the flavours in suspension for an optimum time. Typically, the non-animal based tuna flavouring is added from a mixing tank. These steps result in an optimum distribution of the non-animal based tuna flavouring in the plant protein mixture.

In a second aspect, the invention provides a tuna analogue comprising at least two different plant proteins and a non-animal based tuna flavour, wherein said plant proteins comprise wheat gluten and at least one other plant protein selected from pea protein, soy protein, faba bean protein, and canola protein, and wherein wheat gluten comprises between 10 to 40 wt % of total plant protein in the tuna analogue.

The tuna analogue is obtainable by a method as described herein.

In some embodiments, the tuna analogue is devoid of added salt. In some embodiments, the tuna analogue is devoid of hydrocolloids.

In a third aspect, the invention provides a food product comprising the tuna analogue as described herein.

In some embodiments, the food product is devoid of animal products.

In a fourth aspect, the invention provides for the use of a plant protein mixture to make a tuna analogue, wherein said plant protein mixture comprises wheat gluten and plant protein selected from pea protein, faba bean protein, soy protein, and canola protein, and wherein wheat gluten comprises between 10 to 40% of the total plant protein in the plant protein mixture.

In some embodiments, the plant protein mixture comprises wheat gluten and pea protein in a ratio of about 30:70.

### BRIEF DESCRIPTION OF THE DRAWINGS

FIG. 1—relative intensities of key aroma compounds responsible for off-notes in the fibrous protein product during washing process. The relative intensity is calculated based on the area of the peak corresponding for each molecule divided by the area of the same molecule in the water from the second washing.

FIG. 2—relative intensities of key aroma compounds responsible for off-notes in water used during washing process. The relative intensity is calculated based on the area of the peak corresponding for each molecule divided by the area of the same molecule in the water from the second washing.

### DETAILED DESCRIPTION OF THE INVENTION

### Definitions

As used herein, “about” is understood to refer to numbers in a range of numerals, for example the range of −30% to +30% of the referenced number, or −20% to +20% of the referenced number, or −10% to +10% of the referenced number, or −5% to +5% of the referenced number, or −1% to +1% of the referenced number. All numerical ranges herein should be understood to include all integers, whole or fractions, within the range. Moreover, these numerical ranges should be construed as providing support for a claim directed to any number or subset of numbers in that range.

The term “wt %” or “wt. %” or “% wt.” used in the entire description refers to total weight % of the final product. The recipes in the examples show an illustration of how wt % or wt. % or % wt. is to be understood by the skilled person in the art.

The products disclosed herein may lack any element that is not specifically disclosed. Thus, a disclosure of an embodiment using the term “comprising” includes a disclosure of embodiments “consisting essentially of” and “consisting of” the components identified. Similarly, the methods and uses disclosed herein may lack any step that is not specifically disclosed herein. Thus, a disclosure of an embodiment using the term “comprising” includes a disclosure of embodiments “consisting essentially of” and “consisting of” the steps identified.

Any embodiment disclosed herein can be combined with any other embodiment disclosed herein unless explicitly and directly stated otherwise.

Unless defined otherwise, all technical and scientific terms and any acronyms used herein have the same meanings as commonly understood by one of ordinary skill in the art in the field of the invention.

As used herein, the term “additive” includes one or more of hydrocolloids (e.g. carboxymethylcellulose, methylcellulose, hydroxypropylmethylcellulose, konjac gum, carragenans, xanthan gum, gellan gum, locust bean gum, alginates, agar, gum arabic, gelatin, Karaya gum, Cassia gum, microcrystalline cellulose, ethylcellulose); emulsifiers (e.g. lecithin, mono and diglycerides, PGPR); whitening agents (e.g. titanium dioxide); plasticizers (e.g. glycerine); anti-caking agents (e.g. silicon-dioxide).

The term “plant protein isolate” as used herein is a plant material having a protein content of at least about 80 wt % plant protein on a moisture free basis.

As used herein, the term “pea protein” means “pea protein isolate”, or “pea protein concentrate”, preferably “pea protein isolate”.

The term “substantially aligned” as used herein refers to an arrangement of protein fibres such that a significantly high percentage of the fibres are contiguous to each other at less than about a 45° angle when viewed in a horizontal plane.

The term “protein fibrous product” as used herein refers to the product obtained from a dough or plant protein mixture after application of thermal energy (e.g., heat, steam texturizing), mechanical energy (e.g., pressure, spinning, agitating, shaking, shearing, turbulence, impingement, confluence, beating, friction, wave), radiation energy (e.g., microwave, electromagnetic), or combinations of these methods. The fibrous protein product may be obtained by extrusion, for example wet extrusion.

General Method Steps

The invention provides a method of making a tuna analogue, said method comprising preparing a plant protein mixture comprising wheat gluten, applying heat and pressure to the plant protein mixture, washing, adding a non-animal based fish flavour and mixing to form a tuna analogue.

More specifically, the invention provides a method of making a tuna analogue, said method comprising preparing a plant protein mixture by mixing wheat gluten and at least one other plant protein selected from pea protein, soy protein, faba bean protein, and canola protein, applying heat and pressure to form a fibrous protein product, washing the fibrous protein product in a liquid at least once, adding a non-animal based tuna flavour and mixing to form a tuna analogue.

More specifically, the invention provides a method of making a tuna analogue, said method comprising preparing a plant protein mixture by mixing wheat gluten and at least one other plant protein selected from pea protein, soy protein, faba bean protein, and canola protein, preferably pea protein, wherein wheat gluten comprises between 10 to 40 wt % of total plant protein in the plant protein mixture; applying heat and pressure to the plant protein mixture to form a fibrous protein product; washing the fibrous protein product in a liquid at least once, wherein the fibrous protein product is allowed to absorb the liquid, and wherein the liquid has a temperature of between 60 to 95° C.; adding a non-animal based tuna flavour to the fibrous protein product and mixing to form a tuna analogue; and optionally retorting or pasteurizing the tuna analogue.

Plant Protein Mixture

The plant protein can be in the form of a flour, protein concentrate, or protein isolate. Preferably, the plant protein is in the form of plant protein isolate.

The plant protein mixture of the invention comprises wheat protein, preferably wheat gluten such as vital wheat gluten or whole grain wheat. The plant protein mixture also comprises at least one other plant protein selected from pulse proteins (e.g. pea protein, faba bean protein), corn protein (e.g., ground corn or corn gluten), soy protein (e.g., soybean meal, soy concentrate, or soy isolate), canola protein, rice protein (e.g., ground rice or rice gluten), cottonseed, and peanut meal.

The best plant protein mixture was obtained by mixing wheat gluten together with pea protein. The plant protein mixture preferably comprises wheat gluten and pea protein, or wheat gluten and at least one pea protein, or wheat gluten and two or more different pea proteins.

Wheat protein, for example wheat gluten, comprises between 10 to 40% of total plant protein in the plant protein mixture, or between 15 to 35%, or between 20 to 35%, or between 25 to 35%, or between 28 to 32%, or about 30% of total plant protein in the plant protein mixture.

Preferably, pea protein comprises between 60 to 90% of total plant protein in the plant protein mixture, or between 65 to 85%, or between 65 to 80%, or between 65 to 75%, or about 70% of total plant protein in the plant protein mixture.

Preferably, the wheat gluten and pea protein are present in the plant protein mixture in a ratio of between 20:80 to 40:60, or between 25:75 to 35:65, or between 28:72 to 32:68, or about 30:70.

The plant protein mixture may comprise wheat gluten and other plant proteins. For example, it may comprise wheat gluten and faba bean protein; or wheat gluten and soy protein; or wheat gluten and canola protein. It may comprise wheat gluten and two different faba bean proteins, or wheat gluten and two different soy proteins, or wheat gluten and two different canola proteins.

The plant protein mixture should be properly hydrated. In some embodiments, the plant protein mixture has a water content of more than 40 wt %, or more than 45 wt %, or more than 50 wt %. The water content of the plant protein mixture may be between 40 to 70 wt %, or between 45 to 60 wt %, or between 50 to 60 wt %, or about 55 wt %.

Where the plant protein mixture comprises wheat gluten and pea protein, wherein the ratio of wheat gluten:pea protein is about 30:70, then the fibrous protein product should have a maximum force (in Newtons) of between 100 to 400, or between 150 to 350, or between 200 to 300. Preferably, the fibrous protein product before washing has a maximum force of 267.8±26.9 (in Newtons). Preferably, the texture measurement has this maximum force when measured using a Kramer cell probe, preferably as described herein.

Wet Extrusion Process

The fibrous protein product can be made using a wet extrusion process. A plant protein mixture can be mixed for about 3 minutes to form a homogenous dough. It can then be pumped, for example at about 15 kg/h. The fibrous protein product may be prepared using a twin screw extruder.

In some embodiments, the extrusion process involves applying heat to the plant protein mixture so that the plant protein mixture reaches a temperature greater than 130° C., preferably greater than 145° C., most preferably greater than 160° C. The plant protein mixture can reach a temperature of between 130° C. to 180° C., or between 140° C. to 170° C.

A slit die can be connected to the exit of the extruder. The temperature of the die can be maintained below 100° C.

Washing the Fibrous Protein Product in Liquid

The fibrous protein product is washed in a liquid at least once, preferably by immersing the fibrous protein product in a liquid, to allow the fibrous protein product to absorb the liquid. Preferably, after extrusion, the fibrous protein product is immersed in a liquid to allow the fibrous protein product to absorb the liquid.

The advantage of washing is that soluble components are released, some of which may be responsible for off taste. This step also causes mixture swelling, thereby allowing the liquid to access inside the chunks of mixture and to increase the washing of soluble components inside the texturized matrix. The liquid is then partially drained. Best results are achieved if the immersing and partial draining steps are repeated once. Preferably, the plant protein mixture is immersed in the liquid for at least about 10 minutes each time.

The liquid can be, for example, water or broth. The broth may comprise ingredients such as red or brown algae, lemon, and salt.

The liquid has a temperature of between 60 to 95° C., or about 70 to 95° C., or about 75 to 95° C., or about 80 to 90° C. The preferred temperature is about 85° C.

The preferred washing time is at least 10 min.

Typically, the fibrous protein product has a moisture content greater than 70%, or greater than 80% after washing.

Non-Animal Based Tuna Flavouring

Non-animal based tuna flavouring from a commercially available source is added to the fibrous protein product. The flavouring can be a combination of flavourings from a commercially available source. Preferably the flavouring is mixed with oil before adding, preferably rapeseed oil.

Tuna Analogue

The tuna analogue of the invention has an appearance, taste, and texture which resembles conventional tuna, for example canned tuna. It benefits from having healthy and natural ingredients. It is devoid of animal products, or animal derived products. It is typically devoid of one or more of additives, for example hydrocolloids, methylcellulose, gums, alginates, and/or modified starch. The tuna analogue may be devoid of added salt, e.g. sodium chloride.

Retorting

The tuna analogue can be retorted in any suitable receptacle, for example in a can, pouch, tray, food tubes, or glass jar. The tuna analogue may also be pasteurized.

Food Product

The tuna analogue is suitable for adding to various food products. In some embodiments, the food product is devoid of animal products. The preferred temperature of the tuna analogue when consumed on top of a pizza can be at about 60° C. The preferred temperature of the tuna analogue when consumed from a salad box can be at about 15° C. The food product may be, for example, a pizza, sandwich, or a salad box. The tuna analogue may be devoid of added salt, e.g. sodium chloride.

Those skilled in the art will understand that they can freely combine all features of the present invention disclosed herein. In particular, features described for the compositions of the present invention may be combined with the method or uses of the present invention and vice versa. Further, features described for different embodiments of the present invention may be combined. Where known equivalents exist to specific features, such equivalents are incorporated as if specifically referred to in this specification.

Further advantages and features of the present invention are apparent from the figures and non-limiting examples.

### EXAMPLES

### Example 1

Plant Protein Mixture Recipes

Plant protein mixtures were prepared using pea protein isolate alone, wheat gluten alone, wheat gluten:pea protein isolate in combination (70:30), and wheat gluten:pea protein isolate in combination (30:70).

A Twin Screw Extruder (TSE) was used to prepare a fibrous protein product in which the fibres were not substantially aligned. A dough was prepared in a Planetaria Tekno mixer at 30 rpm by mixing 0.2 kg plant protein mixture and 75 g rapeseed oil.

The mixture was mixed for three minutes to form an homogeneous dough. This dough was then pumped to the first barrel of the extruder at 15 kg/h. The process conditions used a temperature higher than 160° C. A slit die was connected to the exit of the extruder. The temperature of the die was maintained below 100° C.

The mixture is produced without any colour and flavour ingredients and is used as a semi-finished product to manufacture the finished canned tuna product. The semi-finished mixture product was boiled (washed) twice in water at 85° C. for 10 minutes. This boiling step allowed the chunks to uptake water and swell. The water boiling steps also modified the texture and dryness of the mixture. In particular the boiling step reduced the gumminess perception, and created spaces in between fibre bundles and give a structure closer to a tuna fibrous organization. Furthermore, the off-taste of the pea was reduced. Without wishing to be bound by theory, it is believed that part of the off-taste components are washed-out by the water, thereby leading to an improvement in the final tuna flavour profile.

The excess water from the boiled mixture was then drained through a sieve and the mixture was chilled (5° C.) for further processing. The water draining step was controlled so that the mixture moisture was kept at a sufficient level for preserving the chunk swelling. The wetness and juiciness of the chunks was important for the tuna flesh mouthfeel perception.

The texture, elasticity, and “bitiness” characteristics of each plant protein mixture is shown in Table 2:

| Plant protein mixture | Water content | Characteristics |
|---|---|---|
| Pea protein | 56% | Lacking fibrous texture, elasticity |
| | | and “bitiness” |
| Wheat Gluten | 58% | Highly fibrous, elastic squid-like |
| | | texture |
| Wheat gluten:pea protein | 58% | Highly fibrous, elastic, with |
| (70:30) | | “meaty” texture |
| Wheat gluten:pea protein | 56% | Good tuna fibrous texture, |
| (30:70) | | appropriate elasticity and |
| | | “bitiness” |

The preferred blend of protein isolates combined those which are able to produce a strong fibrous texture (wheat gluten) and a reduced ability to produce fibrous texture (pea protein isolate) in a ratio of 30:70. This composition results in the best tuna like material with optimal structure and texture.

Texture measurements of the preferred blend were performed using a Krammer cell probe with 4 knifes cutting through the samples (“Kramer Shear Cell-4 blades-8.8 cm”). The following parameters were used: 50 kg load cell, test speed 1 mm/s, starting position 10 mm, distance 18 mm, and 10 samples per variant. The sample comprising wheat gluten and pea protein (30:70) had a maximum force (in Newtons) of 267.8±26.9.

The chilled mixture chunks were mixed with tuna flavor and weighed in glass jars or cans before retorting. The closed jars were then sterilized in an autoclave for 3 minutes at 122° C. in accordance with quality and safety procedures.

### Example 2

Effect of Immersing Protein Fibrous Product in Hot Water

Plant protein isolates are characterized by their undesired green notes and their reduction positively impacts the acceptance of products containing such products. The effect of immersing the fibrous protein product in hot water to reduce undesired notes was assessed. The product comprised wheat gluten:pea protein, 30:70, with no added flavors. Samples consisting of a plant protein mixture pre-boiled, after a first boiling step and a second boiling step, as well as the water used during this treatment were analyzed for changes in the volatile molecules responsible for off-notes.

1 g of product was placed into a 10 mL headspace-vial closed with a magnetic cap (VWR, Part #1548-0132) and septum (silicone lined PTFE septum, 20 mm, VWR, Part #1548-0596). Samples were kept at 6° C. until analysis. Volatile compounds were measured by static headspace technique which collected the volatiles present in the headspace of the sample. The volatile extraction from the headspace was done using a MPS2 auto sampler (Gerstel) equipped with a SPME fiber (PDMS/DVB, 1 cm length, 65 μm, Agilent, Part #SU57345U). The vial was transferred into the incubator for 15 minutes at 30° C. to allow the headspace to reach equilibrium. Afterwards, the headspace-SPME extraction was performed for 20 minutes and the fiber was desorbed for three minutes in the GC injector at 240° C. in splitless mode.

A GC capillary column DB-WAX (60 m, ID 0.25 mm, 0.25 μm film thickness, J & W, Part #122-7062) was used for the chromatographic separation. The column was installed on an Agilent GC 6890A, equipped with an Agilent 5973 mass spectrometer detector. The oven temperature was held at 30° C. for 3 minutes, raised to 240° C. at 6° C./min and then held at 240° C. for 15 minutes. Helium was the carrier gas and run at a constant flow rate of 1.5 mL/min. MS acquisitions were achieved in El ionization mode at 70 eV from m/z 29 to 300 amu with 7.54 scans per second. Compounds were tentatively identified by comparison of mass spectrum with mass spectral libraries (Commercial: Wiley11Nist14, and internally developed libraries) and Kovats Indices. Experimental retention indices were obtained by the injection of an alkane solution (C5-C25 fraction).

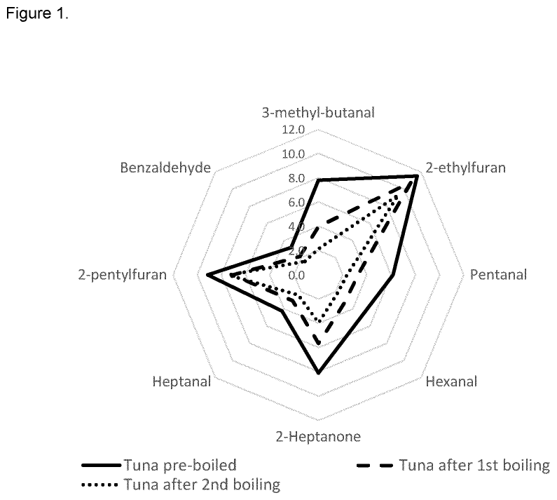

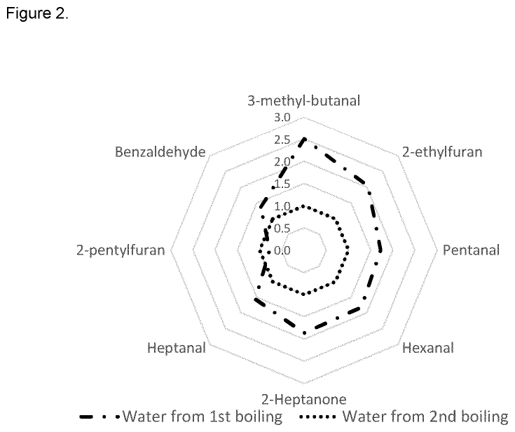

During the process followed for this material, many of the characteristic volatile compounds responsible for such green notes, as well as other undesired flavors were reduced as shown in FIG. 1. Hexanal, 2-heptanone, heptanal, and 3-methyl-butanal can be responsible for a green aroma descriptor, whereas 2-ethylfuran is associated with musty and solvent like notes, and benzaldehyde with almond aroma. For most of them, the first boiling step produces the largest reduction, except for 2-ethylfuran. Hexanal, one of the key drivers for green character in such material, displays a 37% reduction during the first boiling step and 30% additional reduction during the second boiling. This matches the observations by the panel during sensory tasting. In addition, the presence of the molecules were detected in the water used during boiling. A decrease was seen from the first boiling to the second boiling step (FIG. 2).

1. A method of making a tuna analogue, said method comprising
a. Preparing a plant protein mixture by mixing at least two different plant proteins, wherein said plant proteins comprise wheat gluten and at least one other plant protein selected from the group consisting of pea protein, soy protein, faba bean protein, and canola protein and wherein wheat gluten comprises between 10 to 40% of total plant protein in the plant protein mixture;
b. Applying heat and pressure to the plant protein mixture to form a fibrous protein product;
c. Washing the fibrous protein product in a liquid at least once, wherein the fibrous protein product is allowed to absorb the liquid, and wherein the liquid has a temperature of between 60 to 95° C.; and
d. Adding a non-animal based tuna flavour to the fibrous protein product and mixing to form a tuna analogue.

2. The method according to claim 1, wherein the plant protein mixture is prepared by mixing wheat gluten and pea protein in a ratio of about 30:70.

3. The method according to claim 1, wherein the plant protein mixture is prepared by mixing wheat gluten and two or more pea proteins.

4. The method according to claim 1, wherein the plant protein mixture is prepared by mixing wheat gluten, pea protein and at least one other plant protein.

5. The method according to claim 1, wherein heat and pressure are applied to the plant protein mixture by a wet extrusion process to form a fibrous protein product.

6. The method according to claim 1, wherein heat is applied to the plant protein mixture so that the plant protein mixture reaches a temperature of at least 130° C.

7. The method according to claim 1, wherein the fibrous protein product is washed in the liquid at least twice, and wherein the fibrous protein product is allowed to absorb the liquid, and wherein the liquid has a temperature of about 85° C.

8. The method according to claim 1, wherein the fibrous protein product has a moisture content of at least 70 wt % after washing.

9. The method according to claim 1, wherein the non-animal based tuna flavouring is mixed in oil before adding to the plant protein mixture.

10. A tuna analogue comprising at least two different plant proteins and a non-animal based tuna flavour, wherein said plant proteins comprise wheat gluten and at least one other plant protein selected from the group consisting of pea protein, soy protein, faba bean protein, and canola protein, and wherein wheat gluten comprises between 10 to 40% of the total plant protein in the tuna analogue.

11. The tuna analogue according to claim 10, wherein wheat gluten comprises about 30% of the total plant protein and pea protein comprises about 70% of the total plant protein.

12. A tuna analogue obtained by a method according claim 1.

13. (canceled)

14. A plant protein mixture comprising wheat gluten and at least one other plant protein selected from the group consisting of pea protein, soy protein, faba bean protein, and canola protein, and wherein wheat gluten comprises between 10 to 40% of the total plant protein in the plant protein mixture.

15. Plant protein mixture according to claim 14, wherein the plant protein mixture comprises wheat gluten and pea protein in a ratio of about 30:70.
